(19) United States
(12) Patent Application Publication
(10) Pub. No.: US 2011/0081193 A1
(43) Pub. Date: Apr. 7, 2011

(54) METHOD AND ARRANGEMENT RELATED TO A SWING DAMPER

(76) Inventor: Lars Gunnar Nilsson, Vindeln (SE)

(21) Appl. No.: 12/737,080

(22) PCT Filed: Jun. 4, 2009
(86) PCT No.: PCT/SE2009/000288

§ 371 Date: Dec. 6, 2010

(30) Foreign Application Priority Data
Jun. 8, 2008 (SE) 0801333-6

(51) Int. Cl. B66C 13/06; F16C 11/10

(52) U.S. Cl. 403/91

(57) ABSTRACT

The invention relates to a method and an arrangement pertaining to a swing damper, particularly a swing damper (10) for supporting tools/implements (5) suspended from a crane jib (1) or the like. The swing damper (10) includes a first swing joint/bearing (3) with a first brake arrangement (21, 22, 45) and a second swing joint/bearing (4) with a second brake arrangement (31, 32, 46). The desired degree of braking and/or the fixing of the desired swing position is/are achieved by operating a controller (50) operating between the first brake arrangement and the second brake arrangement.

### TECHNICAL FIELD

This invention relates to a method pertaining to a swing damper according to the pre-characterising part of claim 1. The invention also relates to an arrangement pertaining to a swing damper.

### BACKGROUND OF THE INVENTION

When swing dampers are used to support different types of tools/accessories/implements, e.g. suspended from a crane jib, it is desirable to achieve effective and reliable braking or damping of the oscillating movement that normally occurs, e.g. when operating the crane jib and performing different tasks. Position-locking braking is sometimes another aim.

Swing dampers can be used in association with all conceivable types of tools, e.g. suspended from the tip of a crane, e.g. different types of forestry machines, such as clearing units, etc.

### AIM OF THE INVENTION

One aim of this invention is to provide an extremely advantageous brake arrangement and fixing arrangement relating to a swing damper, as well as a braking method and a fixing method.

The aim is achieved in that the method and the arrangement have the features specified in the claims.

### ADVANTAGES OF THE INVENTION

A tool/implement which swings when a crane jib moves can be fixed rapidly in the desired position, thereby saving time and increasing capacity.

Free swinging, basic braking and fixing of the tool/implement are all possible depending on the degree of actuation of the brake.

Breaking stresses acting on the crane jib are reduced compared to the use of a conventional swing damper with constant braking.

In association with forestry machines, e.g. the swing damper can be fixed so as to simplify the handling of a cut tree. Locking in any desired tilted position allows for large time savings in various fields of application.

The invention has both technical and economic advantages.

### BRIEF DESCRIPTION OF THE DRAWINGS

FIG. 1 is a side view of an arrangement according to the invention supported by a crane jib and supporting a tool/implement.

FIG. 2 is an exploded view of the arrangement according to FIG. 1.

FIG. 3 is a vertical section of the arrangement.

FIG. 4 is a vertical section of the arrangement in a locked tilted position.

FIG. 5 is a vertical front section of the arrangement in a locked tilted position.

### DETAILED DESCRIPTION OF THE ILLUSTRATED EMBODIMENT

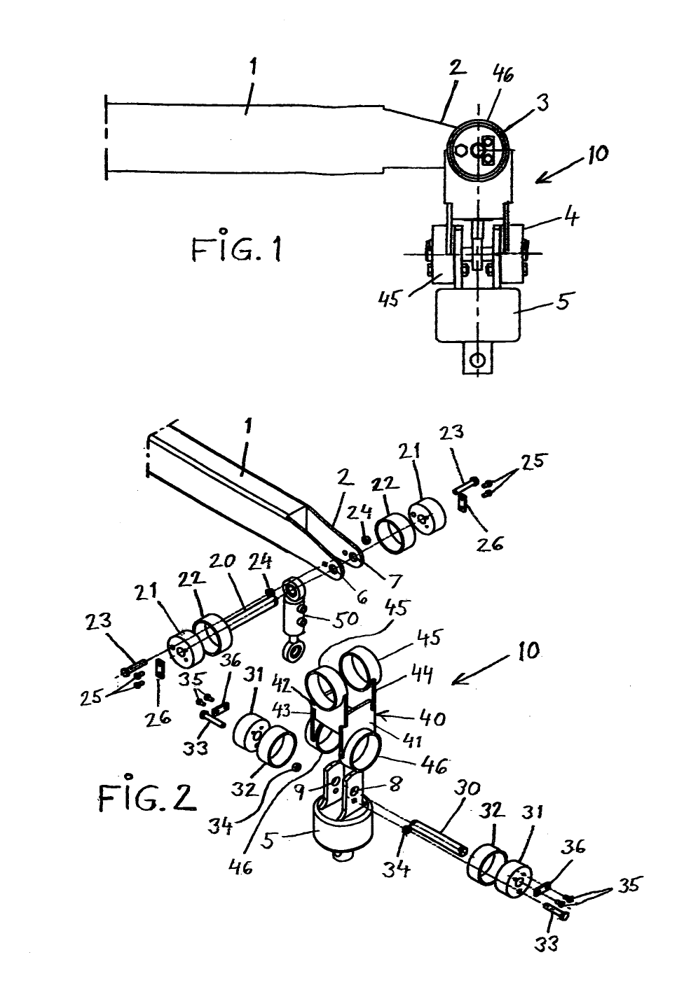

FIG. 1 shows a swing damper 10 according to the invention swing-mounted at the tip 2 of a crane jib 1 by means of a first swing joint/bearing 3. In the case shown, the swing damper 10 supports an accessory/tool/implement in the form of a rotator 5 at its lower end by means of a second swing joint/bearing 4, and the rotator in turn, e.g. can support a suitable working tool or working implement (not shown). The swing bearings 3 and 4 are arranged approximately at right angles to one another in order to allow for swing movements in different directions.

As will be clear from FIG. 2, the swing damper 10 thus includes a first pin 20 for mounting in mounting holes 6, 7 in the tip 2 of the crane. The pin 20 is provided at its ends with a circular brake block 21 with a circumferentially arranged brake lining 22 bonded to the respective brake block 21. One end of a controller 50, e.g. a hydraulic cylinder, is anchored to the central region of the pin 20. The brake blocks 21 with the brake linings 22 are secured against rotation relative to the crane jib 1 by means of bolts 23 and nuts 24. The pin 20 is fixed axially relative to the brake blocks 21 by means of bolts 25 and locking washers 26.

In a corresponding manner, a second pin 30 is designed to be mounted in mounting holes 8, 9 in the accessory/tool 5. The pin 30 is provided at its ends with a circular brake block 31 with a circumferentially arranged brake lining 32 bonded to the respective brake block 31. The other end of a controller 50, e.g. a hydraulic cylinder, is anchored to the central region of the pin 30. The brake blocks 31 with the brake linings 32 are secured against rotation relative to the accessory 5 by means of bolts 33 and nuts 34. The pin 30 is fixed axially relative to the brake blocks 31 by means of bolts 35 and locking washers 36.

The arrangement according to the invention furthermore includes a central part 40 forming a unit including four disc elements/plates 41-44, wherein the plates 42,44 each support a first brake drum 45 and the plates 41, 43 each support a second brake drum 46. The controller/hydraulic cylinder 50 extends through the central part 40 in order to engage with the pins 20 and 30.

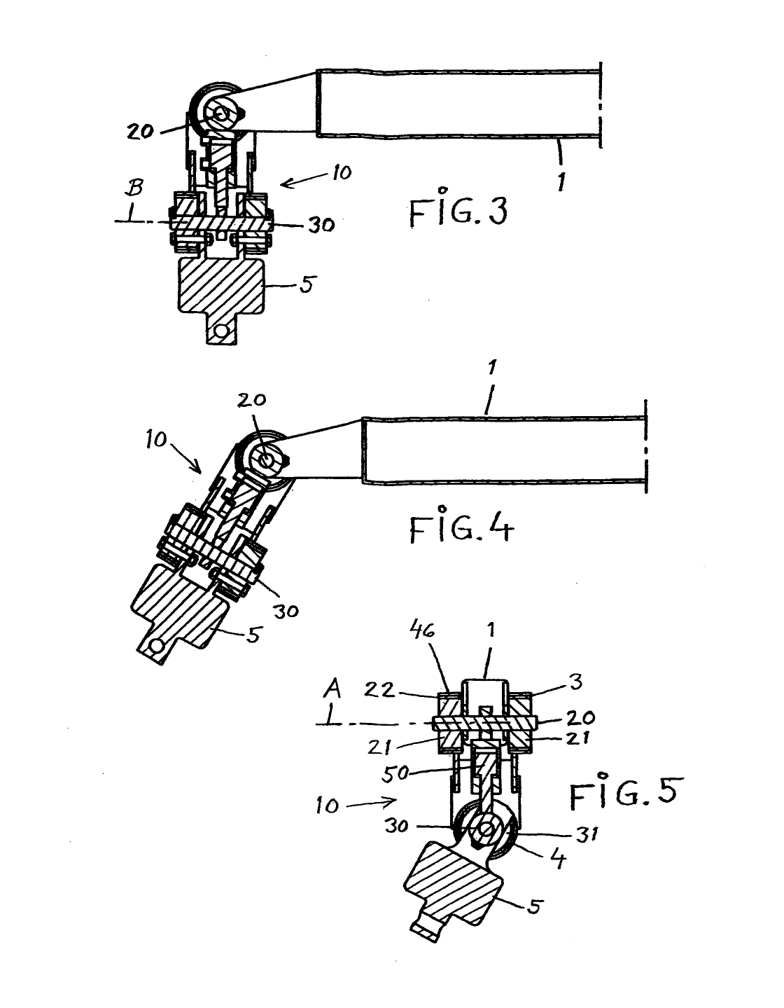

The detailed design and mounting sequence of the arrangement will be clear from FIGS. 1-3.

The arrangement according to the invention operates as follows. When the controller 50 is in the inoperative position (neutral position), oscillating movement is possible in that the brake linings 22 and 32 run relatively smoothly in the brake drums 45 and 46, as a result of which relatively low-friction bearings 3, 4 are obtained when the brake arrangement is not activated. The centre lines of the bearings 3 and 4 are designated A and B respectively. When the controller 50 is longitudinally extended (or longitudinally compressed), the oscillating movement is braked as the contact pressure between the brake linings 22,32 and the brake drums 45,46 increases. The controller 50 operates between the pins 20 and 30, as a result of which the contact pressure of the brake linings relative to the brake drums can be varied as desired. The degree of braking can thus be selected by adjusting the length of the controller so as to obtain the desired force control. Fixing in a desired swing position is also possible by operating the controller so as to obtain brake locking. It is thus possible to achieve any desired braking pattern with the arrangement according to the invention. It is thus also possible to select basic braking giving the swing damper acceptable basic characteristics.

FIGS. 4 and 5 show examples of how the arrangement can be fixed as required in any desired swing positions during desired operating cycles. This is very useful when the arrangement, e.g. supports tools/implements for forestry thinning and clearing and also in various other contexts.

Components may of course be replaced by functionally equivalent components within the scope of the inventive concept. The material selection may of course also be varied.

It is also possible to vary the detailed design of the brake arrangement, e.g. by using only one first brake member and one second brake member so as to obtain a simpler brake.

The invention is thus not limited to the embodiment illustrated and described and changes and modifications are of course possible within the scope of the following claims.

1. Method relating to a swing damper, particularly a swing damper (10) for supporting tools/implements (5) suspended from a crane jib (1) or the like, characterised in that the swing damper (10) includes a first swing joint/bearing (3) with a first drum brake arrangement (21, 22, 45) and a second swing joint/bearing (4) with a second drum brake arrangement (31, 32, 46) and that the desired degree of braking and/or the fixing of the desired swing position is/are achieved by operating a controller (50) acting between the first drum brake arrangement and the second drum brake arrangement by longitudinally extension or compression of the controller (50).

2. Arrangement relating to a swing damper, particularly a swing damper (10) for supporting tools/implements (5) suspended from a crane jib (1) or the like, characterised in that the swing damper (10) includes a first swing joint/bearing (3) with a first drum brake arrangement (21, 22, 45) and a second swing joint/bearing (4) with a second drum brake arrangement (31, 32, 46) and that a controller (50) is designed to operate between the first drum brake arrangement and the second drum brake arrangement, a first brake block pair (21, 21) is connected together by means of a first pin (20), and a second brake block pair (31, 31) is connected together by means of a second pin (30) and the controller (50) is designed to operate between the first pin (20) and the second pin (30).

3. Arrangement according to claim 2, characterised in that the first swing joint/bearing (3) and the second swing joint/bearing (4) are oriented in different direction (A,B).

4. Arrangement according to claim 2, characterised in that the controller (50) is a hydraulic cylinder.

5. Arrangement according to claim 2, characterised in that it includes a central part (40) comprising brake drums (45, 46).

6. Arrangement according to claim 2, characterised in that it includes circular brake blocks (21, 31) with circumferentially arranged brake linings (22, 32).

7. Arrangement according to claim 2, characterised in that the first brake block pair (21, 21) is secured against rotation relative to a crane jib tip (2) and that the second brake block pair (31, 31) is secured against rotation relative to a holder of an implement/accessory/tool (5).

8. Arrangement according to claim 3, characterised in that the controller (50) is a hydraulic cylinder.

9. Arrangement according to claim 3, characterised in that it includes a central part (40) comprising brake drums (45, 46).

10. Arrangement according to claim 4, characterised in that it includes a central part (40) comprising brake drums (45, 46).

11. Arrangement according to claim 3, characterised in that it includes circular brake blocks (21, 31) with circumferentially arranged brake linings (22, 32).

12. Arrangement according to claim 4, characterised in that it includes circular brake blocks (21, 31) with circumferentially arranged brake linings (22, 32).

13. Arrangement according to claim 5, characterised in that it includes circular brake blocks (21, 31) with circumferentially arranged brake linings (22, 32).

14. Arrangement according to claim 3, characterised in that the first brake block pair (21, 21) is secured against rotation relative to a crane jib tip (2) and that the second brake block pair (31, 31) is secured against rotation relative to a holder of an implement/accessory/tool (5).

15. Arrangement according to claim 4, characterised in that the first brake block pair (21, 21) is secured against rotation relative to a crane jib tip (2) and that the second brake block pair (31, 31) is secured against rotation relative to a holder of an implement/accessory/tool (5).

16. Arrangement according to claim 5, characterised in that the first brake block pair (21, 21) is secured against rotation relative to a crane jib tip (2) and that the second brake block pair (31, 31) is secured against rotation relative to a holder of an implement/accessory/tool (5).

17. Arrangement according to claim 6, characterised in that the first brake block pair (21, 21) is secured against rotation relative to a crane jib tip (2) and that the second brake block pair (31, 31) is secured against rotation relative to a holder of an implement/accessory/tool (5).

18. Arrangement according to claim 8, characterised in that it includes a central part (40) comprising brake drums (45, 46).

19. Arrangement according to claim 8, characterised in that it includes circular brake blocks (21, 31) with circumferentially arranged brake linings (22, 32).

20. Arrangement according to claim 8, characterised in that the first brake block pair (21, 21) is secured against rotation relative to a crane jib tip (2) and that the second brake block pair (31, 31) is secured against rotation relative to a holder of an implement/accessory/tool (5).
